(19) United States
(12) Patent Application Publication
(10) Pub. No.: US 2007/0120701 A1
(43) Pub. Date: May 31, 2007

(54) Transmitter to bottle attachment means

(76) Inventor: David Teller, Miami, FL (US)

Correspondence Address: David Teller, P.O. Box 02-5284, Miami, FL, 33102-5284, US

(21) Appl. No.: 11/286,425

(22) Filed: Nov. 25, 2005

(51) Int. Cl. G08B 23/00; G08B 13/14

(52) U.S. Cl. 340/693.9; 340/572.8

(57) ABSTRACT

Transmitter housing to bottle attachment assembly where the housing can be removed and replaced from the attaching member. In a preferred embodiment, a bottle neck attachment platform includes outwardly extending longitudinal ribs that can slidably engage L shaped members located on the back of the housing. The platform also includes a semi-rigid tab having an aperture capable of receiving a protrusion located on the back side of the housing so that the housing can be removed after contents of the bottle is used up. The platform has an integral standard cable tie strap protruding from one side which can be inserted into a mating aperture located in the platform. The transmitter housing includes accommodation for either a mechanical switch or hall effects magnetic switch that engages with the surface of the bottle neck thereby turning the transmitter on.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of attachment mechanisms and more specifically to a transmitter housing to bottle attachment means. Bars and restaurants lose a significant amount of revenue due to pilferage at the point of sale, pilferage of bottles from the bar and storage areas and dispensing of drinks to “buddies” as well as due to manual, delayed, and error-prone methods of establishing and keeping metrics. Critical metrics such as pouring cost, pour accuracy and inventory values are calculated as infrequently as once a month. The task of counting and measuring beverage inventory is time consuming and open to intentional and unintentional errors.

In my U.S. Pat. No. 6,504,481 titled “Service Transaction Monitoring System, Method and Device, I disclose a system, method and device for monitoring service transactions, in particular, the dispensing of liquids. The system includes an electronic sensor device, data receiver, and personal computer. The system provides a method for automatically detecting dispensing events including the steps of detecting an event of dispensing a liquid from a standard liquor or other beverage bottle and detecting the type and amount of the liquid dispensed

At the heart of my patented system is the attachment of a transmitting device to a beverage bottle such as a liquor bottle or beer bottle. The attachment means must be easy for a person to apply, difficult for a bar tender to tamper with, yet easy to remove after a bottle of liquor or the like as been consumed. The transmitter housing and attachment assembly must also be able to withstand the rigors of a bar type environment including moisture and rough treatment from bar tenders and cleanup people. Although my original patent disclosed several unique and efficacious methods of transmitter housing attachment to a bottle, I have since discovered other, potentially improved methods of attachment.

### BRIEF SUMMARY OF THE INVENTION

The primary object of the invention is to provide a plurality of unique methods of attaching a transmitter assembly to a beverage bottle.

Another object of the invention is to provide an attachment means that allows a user to remove the transmitter from the bottle for future use.

Another object of the invention is to provide an attachment means that interacts with the bottle so that when a person removes the transmitter, a signal is sent to a central processor.

A further object of the invention is to provide an attachment means that is water resistant.

Yet another object of the invention is to provide an attachment means that does not interfere with the beverage pouring process.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a transmitter housing to bottle attachment means comprising: a transmitter housing, a housing attachment means, and said housing capable of being removable and replaceable from a beverage bottle.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the attachment strap of the first embodiment of the invention.

FIG. 2 is a perspective view of the first embodiment of the invention.

FIG. 3 is a perspective view of an independent strap for the first embodiment of the invention.

FIG. 4 is a perspective view of a second embodiment of the invention.

FIG. 5 is a perspective view of a third embodiment of the invention.

FIG. 6 is a perspective view of a forth embodiment of the invention.

FIG. 7 is a perspective view of a fifth embodiment of the invention.

FIG. 8 is a perspective view of a sixth embodiment of the invention.

FIG. 9 is a perspective view of a seventh embodiment of the invention.

FIG. 10 is a perspective view of an eighth embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

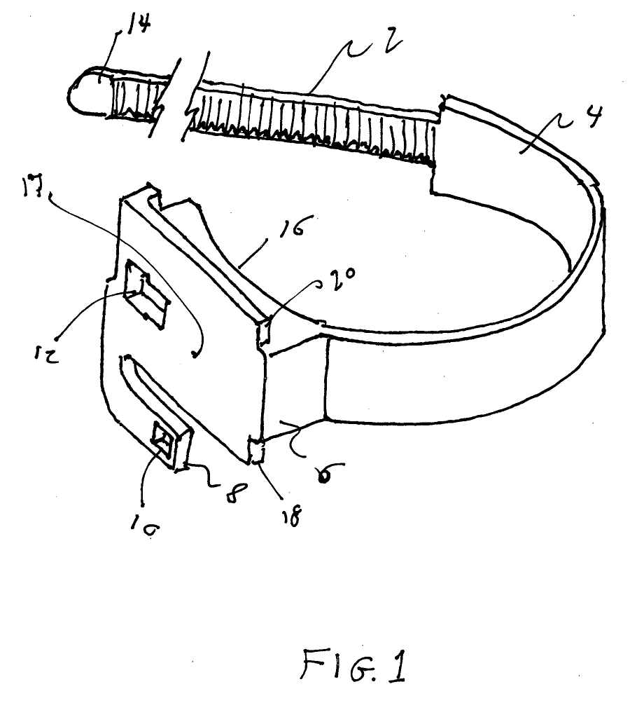

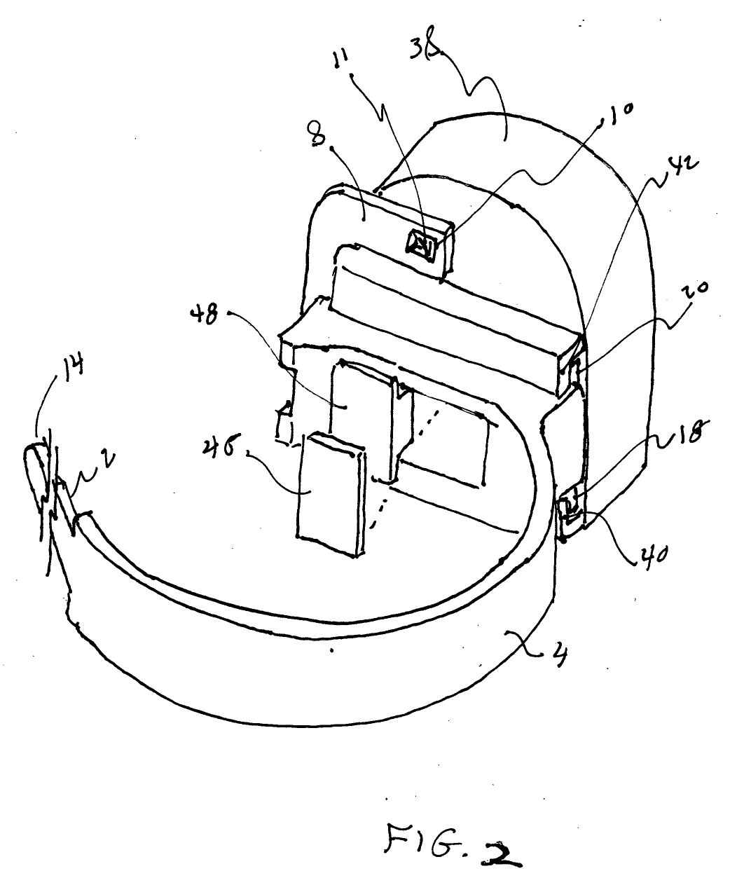

Referring now to FIG. 1 we see a perspective view of a strap that is designed to wrap around the neck of a standard wine bottle or liquor bottle. The entire strap is injection molded as one piece, preferably out of nylon plastic. The C shaped portion 4 wraps around most of the neck. The toothed strap portion 2 terminates in a rounded tongue 14 that can be inserted into an aperture 12 that includes a standard pawl as found in most nylon cable ties. The excess strap 2 is to be trimmed by a standard cable tie cutter so that no portion of strap 2 protrudes beyond the surface of platform 17. Platform 17 is integrated into strap 4 by means of side walls 6 and curved top wall 16. The curve of top wall 16 is designed to match the diameter of a standard wine or liquor bottle. Small differences in the neck diameter of various bottles do not affect the overall performance of the attachment strap shown here. The platform 17 includes integral extension rails 18, 20 that can receive mating L shaped brackets 40, 42 as shown in FIG. 2. Additionally, when the transmitter housing 38 is fully slid onto rails 18, 20 the aperture 10 in tab 8 engages the raised barb 11 located on the back of the transmitter housing 38 so that the housing 38 is locked in place until a person forcefully pulls back on tab 8 thereby flexing it so that raised barb 11 can be disengaged from aperture 10 thereby allowing the entire transmitter housing assembly to be removed for use an another bottle. FIG. 2 also shows a hall effects sensor type switch 48 that becomes activated by magnet 46. Magnet 46 includes an adhesive backing so that it can adhere to the neck of a bottle. The sensor 48 is fixedly attached to the housing 38 so that when a person removes housing 38 the sensor 48 is no longer in close proximity to magnet 46 thereby causing a switching signal within housing 38 that tells the microprocessor located within housing 38 that the transmitter assembly is no longer attached to that particular bottle. FIG. 3 shows an alternate embodiment of the strap assembly where a standard cable tie 30 is used in place of the integral cable tie 4 shown in FIG. 1 and FIG. 2. Notice that the magnet 46 is set into a recess 47 so that when the strap 30 is wrapped around the neck of a bottle, the curved portion 16 can fit snuggly against the bottle neck.

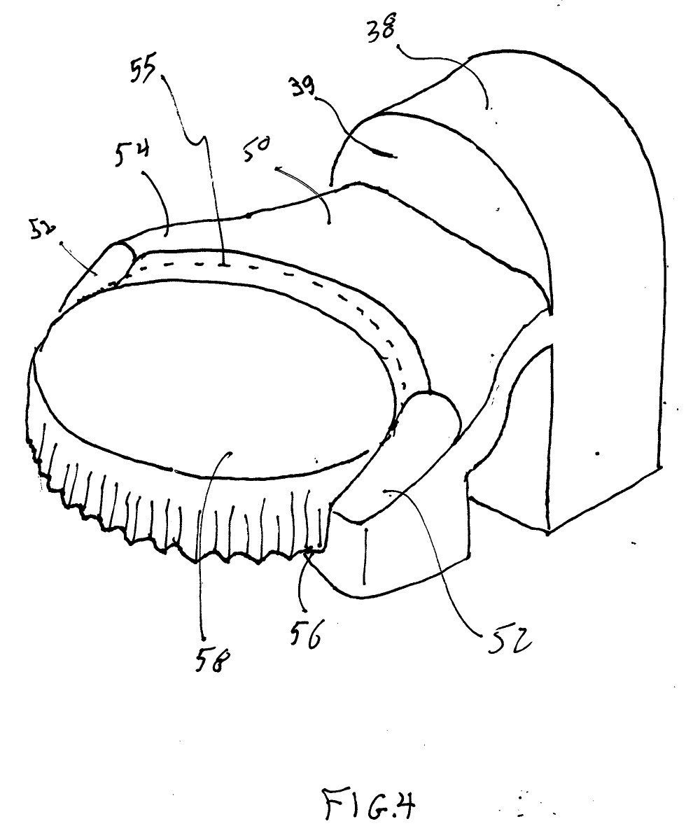

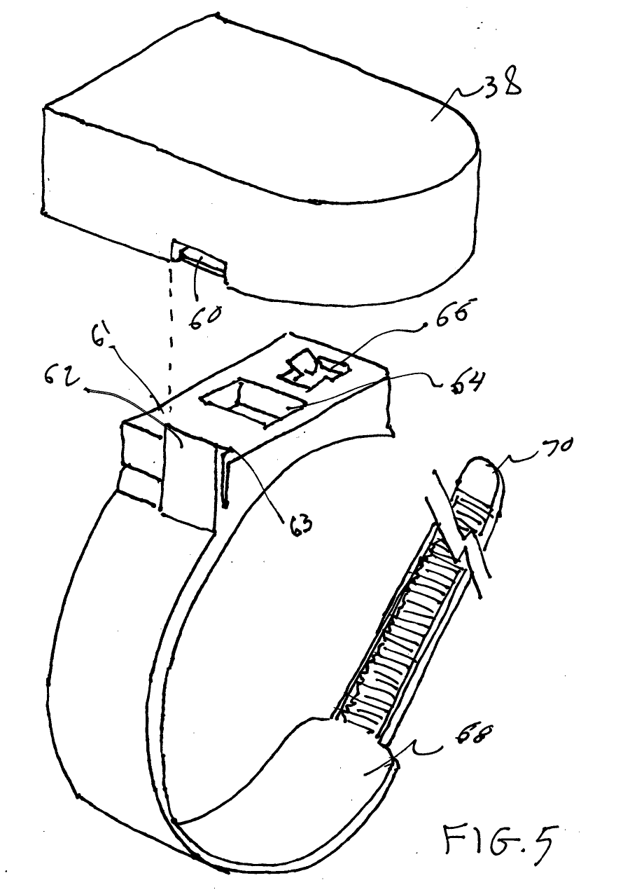

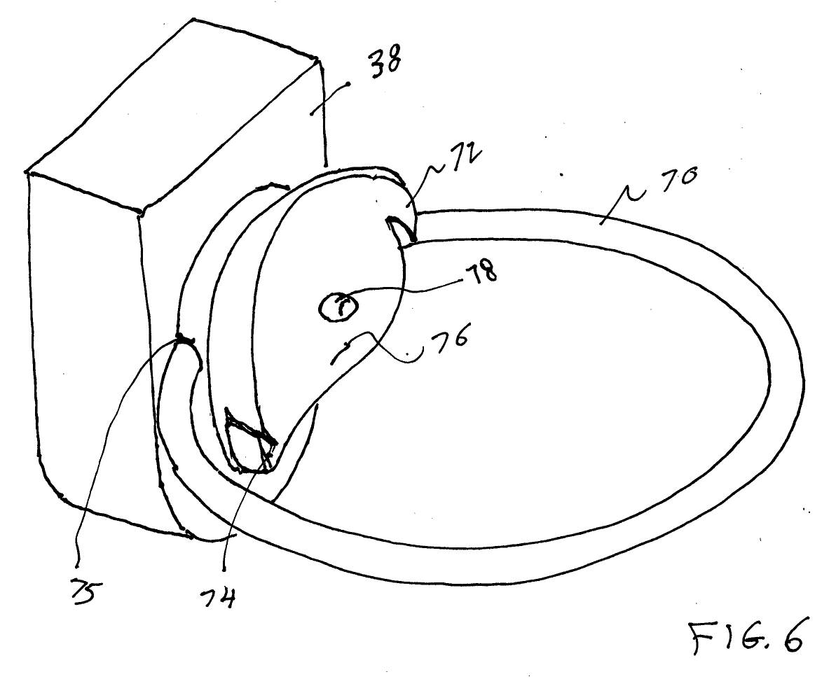

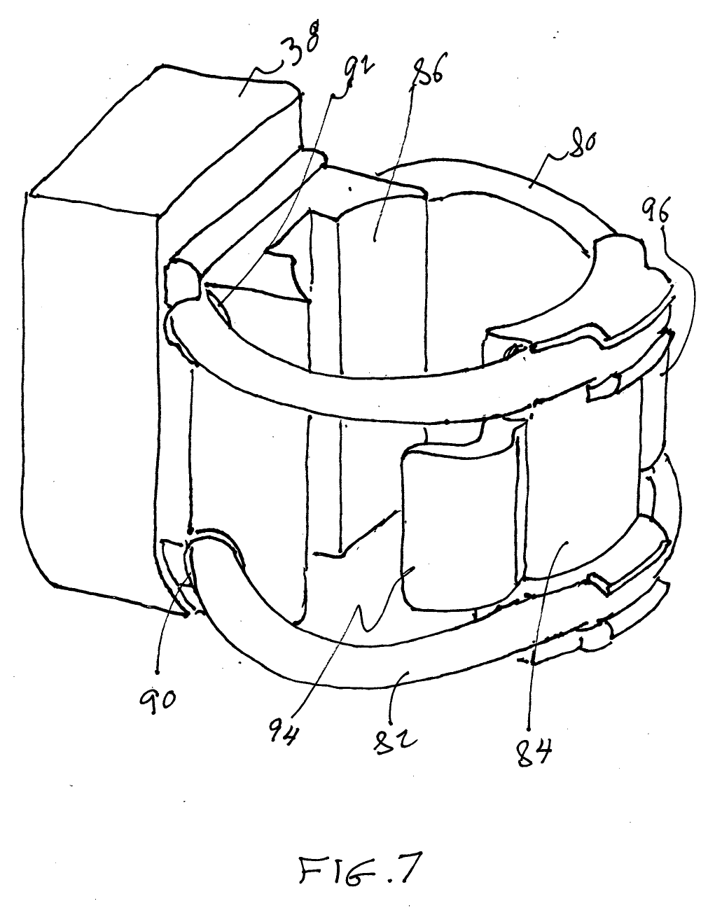

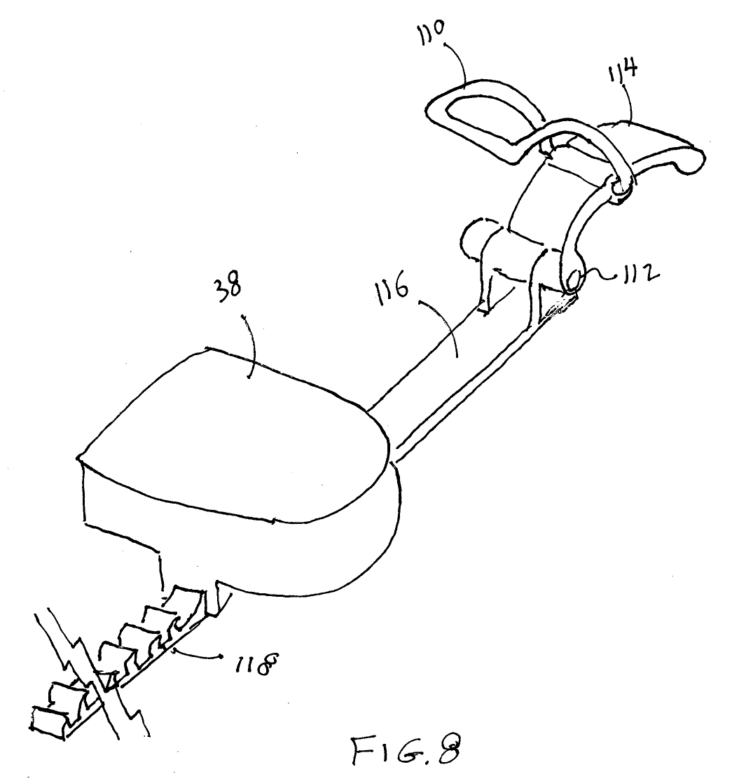

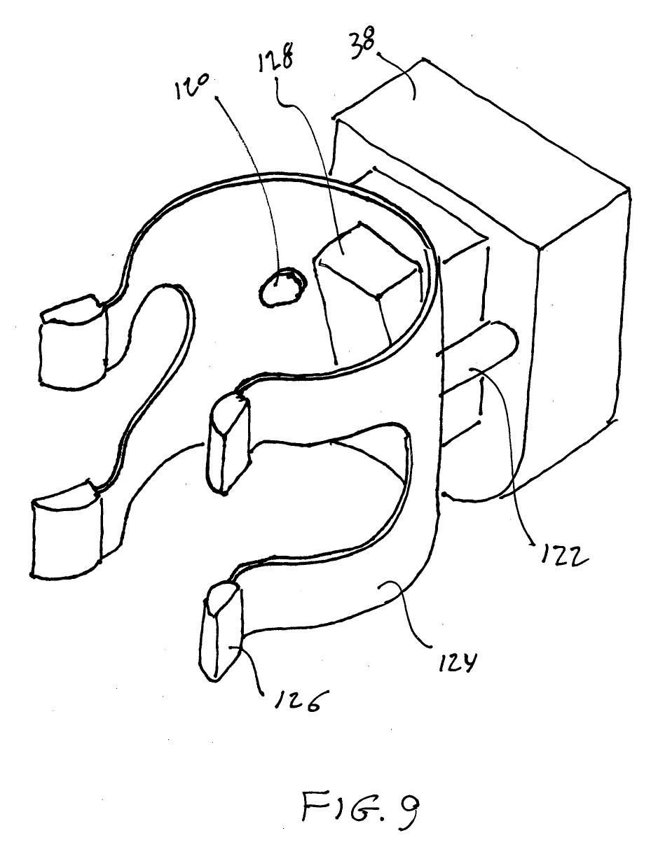

FIG. 4 shows a different embodiment where transmitter housing 38 is fixedly attached to a bottle cap holding assembly. The cap holding assembly consists of a ledge 50 that extends outward from, and is perpendicular to, housing wall 39. The ledge 50 terminates in a C shape 54 goes beyond the mid point of bottle cap 58 by approximately twenty degrees thereby causing a gripping action by the C shape 54. The bottle cap 58 extends under C shaped member 54 as shown by dotted line 55. A bottom ledge 56 retains the lower edge of cap 58. This configuration allows the transmitter housing 38 to be firmly attached to a bottle cap. A switch located between wall 39 and the side of the bottle cap 58 activates the transmitter located in housing 38. When the cap is removed from the bottle, the switch is released thereby indicating to the transmitter that it the bottle has been opened. The mitering 52 of the C member 54 allows a standard bottle cap opener to be applied to the bottle cap to remove the cap from the bottle. Once the cap 58 has been removed from the bottle, the cap can be easily removed from the C shaped cradle 54 because the rigidity of the bottle top is no longer within the cap, thereby allowing the cap sides to deform during removal. FIG. 5 shows another embodiment of the strap version where the strap 68 includes a platform 61 that has a flexible finger 62 with a small ledge that can interact with housing 38 ledge 60 thereby holding the housing 38 onto the platform 61. In the version shown, the aperture 64 would interact with a matching protrusion located under housing 38 thereby allowing one finger 62 to hold the housing in place. Alternately, a second opposing finger could be positioned at the opposite end of the platform to interact with a matching ledge 60 on the opposite side of housing 38. The one finger 62 design is ideal because the user needs to flex one finger to remove the housing 38 rather than two fingers. Aperture 66 accepts tongue 70 as described in the version shown in FIG. 1. FIG. 6 shows another embodiment of the invention where an elastic band 70 is retained by groove 75. In this version, the user slides the band 70 over the top of a bottle and then twists the housing 38 one hundred and eighty degrees causing the band to be caught by wings 72, 74 and thereby holding housing in place on the neck of a bottle. Housing back 76 is curved to match the outside diameter of a standard wine or liquor bottle. When the housing is in place on a bottle, switch button 78 is pressed inward there by signaling to the transmitter located inside housing 38 that a bottle is ready for use and to start transmitting information about liquid dispensing activity. If the housing is removed, the switch 78 is deactivated and this fact is also transmitted. FIG. 7 shows an embodiment of the attachment means that employs two elastic bands 80, 82 to hold housing 38 onto the neck of a bottle. In this embodiment, the user pulls back on tabs 94, 96 thereby extending plate 84 and attached bands 80, 82. The user then slips the assembly over the top of a bottle so that the housing resides firmly against the bottle's neck. Curved portion 86 is designed to fit snuggly against the bottle neck wall. Through grooves 90, 92 retain bands 80, 82 to housing 38. FIG. 8 shows another embodiment of the invention where a strap 116, 118 is molded onto housing 38 the strap 116 terminates in a buckle assembly 114, 110 that pivots about hinge 112. The strap members are flexible so that they can be wrapped around a standard bottle neck so that the buckle portion 110 can interact with the retaining ribs on strap portion 118. The user pushes down on tab 114 for final tightening.

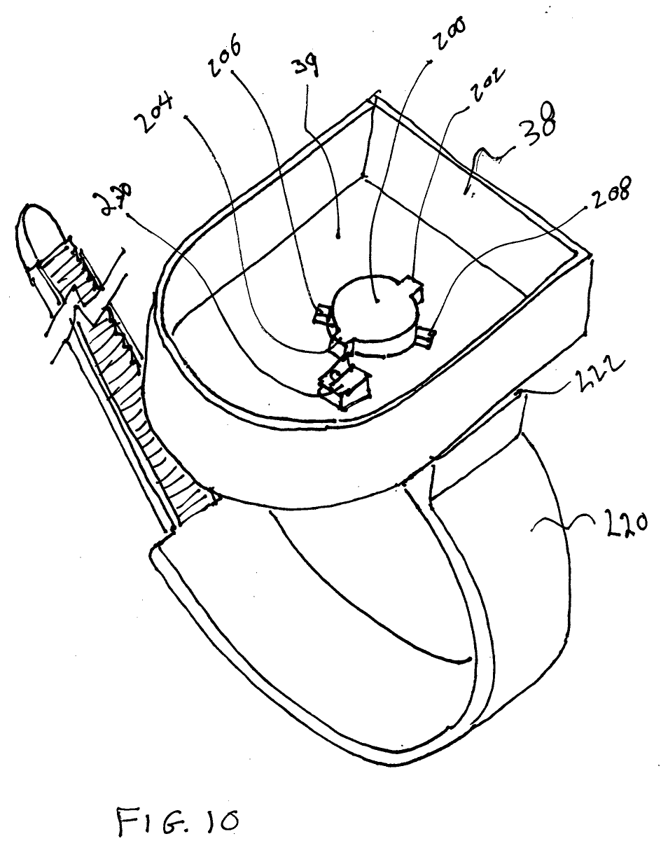

FIG. 9 shows an embodiment of the invention where a C shaped spring metal assembly is attached to housing 38 by rivet heads 120 that cause the metal shape 124 to be held to posts 122. The C shaped spring metal piece 124 includes four fingers that can flex outwards during application and then flex back inward to hold housing 38 snuggly against the neck of a bottle. Switch cap 128 becomes depressed when the assembly is attached to a bottle neck thereby informing the transmitter located within the housing 38 that it is attached to a bottle. Semi-rigid plastic tips 126 cover the ends of the metal fingers thereby protecting the user from the sharp edges of the spring metal. FIG. 10 shows one more way of holding housing 38 onto a strap member 220. A post 200 located on platform 222 includes outwardly extending tabs 202, 204 that can engage with cutouts 206, 208 in the housing wall 39. In this way a standard bayonet attachment means can take place between strap assembly 220 and housing assembly 38. One of the tabs 204 can activate switch 230 when fully engaged with the housing as shown, thereby telling the transmitter normally located inside housing 38 that the housing is attached to a bottle.

Each of the above described and illustrated cases represent a unique and efficient method of attaching a housing to the neck of a standard bottle such as a liquor or wine bottle, where the housing can be removed and replaced on to a new bottle when the old bottle is emptied. In the process of attaching the housing, a switch is activated telling the transmitter located inside that housing that the housing is in place on a bottle neck. In this way, any tampering with the housing during the times that the bottle is in use, will be transmitted and recorded.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Transmitter housing to bottle attachment means comprising:
a transmitter housing;
a housing attachment means; and
said housing capable of being removable and replaceable from a beverage bottle.

2. Transmitter housing to bottle attachment means as claimed in claim 1 wherein a first method of attachment includes a bottle neck attachment assembly including sliding said housing onto a mating platform;
said platform being approximately rectangular and terminating at opposing sides by outwardly extending longitudinal ribs;
said platform also including a semi-rigid tab having an aperture capable of receiving a protrusion located on the back side of said housing so that said housing can be removed after contents of said bottle is used up;
said platform being flat on its housing receiving surface and being radially curved on its bottle neck receiving surface;
said platform ribs capable of slidably engaging L shaped brackets located on said housing back;
said platform having an integral standard cable tie strap protruding from one side;
said cable tie strap capable of being inserted into a mating aperture located in said platform;
said transmitter housing including accommodation for either a mechanical switch or hall effects magnetic switch that engages with the surface of said bottle neck thereby turning said transmitter on.

3. Transmitter housing to bottle attachment means as claimed in claim 2 wherein, in an alternate embodiment, said platform includes an aperture that can accept a standard independent cable tie rather than said integral cable tie.

4. Transmitter housing to bottle attachment means as claimed in claim 1 wherein a second method of attachment includes a bottle cap attachment assembly including a C shaped cap holding arm integrally attached to said transmitter housing;
said C shaped arm ends tapering downwardly to allow room for a standard bottle cap opener to engage said bottle cap;
said C shaped arm including a perpendicular lower ledge that can engage the bottom edge of a standard bottle cap;
said C shape being slightly over one hundred and eighty degrees internally so that it can lock onto said bottle cap;
said C shape capable of flexing outward during attachment and then returning to original shape thereby retaining said bottle cap.

5. Transmitter housing to bottle attachment means as claimed in claim 1 wherein a third method of attachment includes a platform similar to that of the one claimed in claim 2 but where said housing pushes onto said platform;
said platform including an upwardly facing finger having a barbed tip that removebly engages a ledge located in the side wall of said housing.

6. Transmitter housing to bottle attachment means as claimed in claim 1 wherein a fourth method of attachment includes an integral radially curved back surface capable of removably engaging a standard beverage bottle neck;
said back area including an aperture capable of retaining an elastic band;
said housing back also including outwardly extending band retaining fingers so that the user can slide said band over the neck of a bottle and then rotate said housing one hundred and eighty degrees causing said band to tighten and said band portions to engage with said band retaining fingers so that said band remains extended thereby holding said housing firmly on said bottle neck;

7. Transmitter housing to bottle attachment means as claimed in claim 1 wherein a fifth method of attachment includes a transmitter housing having a radially curved back surface capable of mating with the neck of a standard beverage bottle and where a parallel pair of elastic bands are retained by said housing;
said bands also being retained by a curved shaped plastic panel that opposes said housing back so that when a person pulls back on said curved panel, it causes said bands to be stretched so that a person can place said bands over a standard bottle top and then release said curved panel so that said bands retract to hold said housing firmly onto said bottleneck.

8. Transmitter housing to bottle attachment means as claimed in claim 1 wherein a sixth method of attachment includes a transmitter housing having a flexible band protruding from one side that terminates in a buckle assembly and a flexible band protruding from the opposite side that includes a plurality of equally spaced retaining ribs so that when a person wraps said buckle side around a standard bottle neck, said buckle can engage with one of said retaining ribs and be tightened to cause said housing to lock firmly onto said bottle neck.

9. Transmitter housing to bottle attachment means as claimed in claim 1 wherein a seventh method of attachment includes a spring metal C shaped clip that can be pushed onto the neck of a standard beverage bottle.

10. Transmitter housing to bottle attachment means as claimed in claim 1 wherein an eighth method do attachment includes a cable tie assembly as claimed in claim 1 however, said housing is removably attachable by means of a centrally located bayonet type engaging means where said housing includes a circular aperture having a pair of opposing rectangular cutouts that can accept an opposing pair of outwardly facing tabs that are molded onto a circular post mounted to the top surface of said platform area.
